(19) United States
(12) Patent Application Publication
(10) Pub. No.: US 2014/0056645 A1
(43) Pub. Date: Feb. 27, 2014

(54) Flood Control Method

(71) Applicant: Richard C. Hogan, Camarillo, CA (US)

(72) Inventor: Richard C. Hogan, Camarillo, CA (US)

(21) Appl. No.: 14/070,142

(22) Filed: Nov. 1, 2013

Related U.S. Application Data
(63) Continuation-in-part of application No. 12/845,695, filed on Jul. 28, 2010, now abandoned.

(51) Int. Cl. G01W 1/10; E02B 3/02

(52) U.S. Cl. CPC G01W 1/10; E02B 3/02
USPC 405/80; 702/3

(57) ABSTRACT

Provided is a method of identifying and locating high probability areas along a waterway that are likely to flood using real-time data processing of stream gauges and dispatching water capture teams to preventing flooding of the waterway. Water is diverged, blocked, or captured along the waterway to prevent flooding in residential areas. Water is captured in temporary storage devices such as tanks, reservoirs, fabric tube arrays, or available reservoirs, whereafter the collected water can then be analyzed and repurposed after the event. Captured water is tested, treated, and identified. The water can be repurposed or released after the event as necessary. The present method provides a preemptive and long term flood control means for waterways across the country by collecting public source data into a single database, mapping available data points, locating at-risk areas, and coordinating with authorities to divert the water and prepare the local population.

### CROSS REFERENCE TO RELATED APPLICATION

This application is a Continuation in Part of U.S. patent application Ser. No. 12/845,695 filed on Jul. 28, 2010, entitled “Flood Control Method,” now pending, which claims the benefit of U.S. Provisional Application No. 61/229,429, entitled “Flood Control Method” and filed on Jul. 29, 2009. Each patent application identified above is incorporated here by reference in its entirety to provide continuity of disclosure.

### BACKGROUND OF THE INVENTION

### Field of the Invention

The present invention relates to a method of mapping waterway data collected from public sources, analyzing the data using a common platform, and identifying potential flood areas in order to prevent the flood from occurring. Flood areas are predicted prior to a storm event such that flood countermeasures can be deployed to those locations for diversion and capture of the flood water, and further for subsequent redistribution of the captured water after the event to regions in need.

Annual storm and spring thaw-driven floods along the major U.S. rivers and their tributaries have resulted in loss of life and billions of dollars in damages, as well as lost productivity to thousands of American homes, farms, and businesses. Billions of dollars per year is spent on flood claims to FEMA (Federal Emergency Management Agency) and to private insurance, which increases costs for everyone and does not solve the existing problem. Related costs for repair and the substandard insurance products sold to potential flood victims amounts to a negative economic cash flow that affords only minor relief to its victims in an ex post facto manner. The growing costs from these devastating storm events requires new efforts and solutions to address the problem of flooding before the event, as opposed to patchwork solutions after the event has ravaged an area and caused such great economic damage and human suffering.

The present invention comprises a method data collection and analysis that draws from publically available data sources for the purposes of collocating the data, analyzing the data on a single platform and in a uniform manner, and using the data as a means of identifying potential flood points along waterways prior to a storm event. The method operates pre-flood, wherein likely areas to flood along the waterway are identified and potential floods are determined prior to the storm arrival. The method utilizes publically available data from stream gauges, meteorological data, and highly detailed terrain mapping to locate high potential flood points along the waterway. After identification, the method contemplates working with appropriate agencies and local authorities in a coordinated effort to evacuate the area, and further to dispatch water capture teams to the area for diversion and capture of water from the waterway upstream from the potential flood points. The capture water is diverted to existing or newly-made temporary storage area for subsequent testing, treatment, and storage, whereafter the water can be transported to drought areas in need of fresh water.

The present method utilizes steps to collect and analyze data that is made publically available from public agency reports, real-time data, and other sources for the purposes of creating a real-time, highly accurate map of all waterways in the country. The data is analyzed in conjunction with metrological data from weather services, whereby the data from the storm event (anticipated precipitation, wind direction and intensity, waterway surges, etc.) can be compared with the waterway data in real-time and mapped to determine likely flood locations. From these locations, plans can rapidly be made to divert the waterway or shed water therefrom into temporary storage areas to prevent downstream flooding. Data is collected from active sensors and from open sources, whereby the data is collated, analyzed, and plotted to target vulnerable areas as storms develop. The present method is targeted and motivated by serious water issues across the U.S., including the economic waste as a result of flood damage and the areas of the country in which there are shortages of fresh water.

### Description of the Prior Art

Methods and devices for water control and treatment have been disclosed in the prior art. These include patented and published disclosures related to means of controlling waterways and treating water. The present method discloses a new and novel waterway monitoring method and means of actively protecting potential flood areas.

One such device in the art is U.S. Patent Publication No. 2005/0127010 to Rosen, which discloses a process of irrigating landscaped areas that comprises procuring a supply of reclaimed water, testing the reclaimed water for various water quality characteristics, analyzing the collected data, chlorinating and then oxidizing the water prior to irrigating a landscaped area. The method involves irrigating manmade landscaped or agricultural areas using treated and tested reclaimed water. The Rosen method, while providing a new and novel irrigation method for manmade areas, does not contemplate controlling flood areas or collecting water from the flood zone for tagging and relocating for other uses. The Rosen method relates more to procuring and repurposing city or municipality water, treating the same and utilizing the treated water for irrigation of golf courses, farms, and other areas.

The present invention first involves a method of identifying flood prone areas along waterways, whether natural or manmade, for the purposes of preventing an uncontrolled flood before it occurs. Publically available data is gathered into an organized and singular database, wherefrom the data can be compared and manipulated using various techniques to homogenize the data and determine if a single waterway will flood given an impending storm system. Various metrics are gathered from existing and publically available sensor data in the waterways (waterway telemetry), which together with meteorological data, are used to pinpoint locations which are likely to flood and cause damage to the local area. Using this knowledge, local authorities and larger agencies can be coordinated prior to the event, and flood control teams can be dispatched to establish countermeasures against the flood. The countermeasures primarily include diversions of the floodwater so that the water can be temporarily contained. The captured water is then analyzed and optionally treated, whereafter the water can be shipped to areas in need of fresh water.

It is submitted that the present method is substantially divergent in steps from the prior art; the result is consequently an improvement in the art of flood prevention prior to a storm event. In this regard the instant invention is shown as fulfilling a long felt need in the art that will greatly reduce uncontrolled flood events, the damage that results therefrom, along with the associated costs and potential human loss as a result flood unpreparedness.

### Summary of the Invention

In view of the foregoing disadvantages inherent in the known types of flood control methods and devices therefor now present in the prior art, the present invention provides a new method of floodwater analysis and means of anticipating floods along U.S. waterways. It is contemplated that the present method will be utilized for reducing flood events and preventing the damage that results therefrom.

It is an object of the present invention to provide a new and improved flood control method that draws from publically available sensor data in U.S. waterways, whereby the data is gathered, comingled, homogenized, and analyzed for identification of at-risk areas.

The primary object of the present invention to combine public source data along waterways and in flood areas to predict potential floods before they occur. Data collected includes all available stream gauge telemetry already existing in U.S. waterways. Data includes the real-time waterway depth, rate of change in depth of the waterway, the flow rate of the waterway, various metrics on waterway quality, chemical analysis of the waterway, temperature, and other physical data that is collected by the given gauge. Meteorological data related to impending storm systems is compared to the waterway data to determine where the potential flood points along the waterway. The present method enables the timely dispatch of flood capture teams to the anticipated flood locations to reach and set up water diversion equipment or water barriers in the area before the event occurs.

Locations in which a breach in the waterway or an overflow is predicted will be coded based on the waterway locations (notably at points along the river or tributary). These locations will correspond to Federal and State address zip codes, wherein local levies, reservoirs, and related flood ways will also be identified nearby the flood locations using highly detailed terrain maps. Real-time weather predictions are used to project precipitation amounts, rainfall times, locations of storm systems, and wind directions, which are mapped and compared to the data taken from the waterways. Information gathered from the present method can be delivered to the local and Federal authorities for preparation.

All of the gather information is corrected and transformed into a uniform scale and time for subsequent analysis. The data is analyzed and the results are plotted on highly detailed terrain maps, wherein the data is continuously updated on the created maps as the data is translated and analyzed. Commercial digital maps can be utilized to graphically display the data, while areas of low resolution or poor quality can be updated continuously as the map is updated or measurements of the area are incorporated.

Another object of the present invention is to provide a new method of collecting, combining, mapping and maintaining multi-source waterway data for the purposes of planning and dispatching tailored measures for countering or containing the anticipated waterway breach that would otherwise spill into local areas.

Another object of the present invention is to capture the floodwater, to test the captured water, treat the water as necessary, and ship the water to drought areas in need of the fresh water.

Yet another object of the present invention is to test, treat, tag, and temporarily store water at a water capture site, whereby the water can be check for any serious contamination for a follow up on its source location. Environmental enforcement can then investigate improper contamination upstream of the collected water.

A final object of the present invention is to utilize publically available data sources, including existing waterway telemetry, online databases of data, weather service data, and other sources to predict flood locations for the purposes of alerting appropriate agencies, for dispatching water collection teams, and for collecting any diverted water from the flood locations for both economic and environmental uses.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a diagram outlining the various data sources drawn upon by the present method, wherein the data is gathered and combined into a database for analysis and creation of predictive, real-time waterway maps.

FIG. 2 shows a flow diagram outlining the process of collecting and gathering the various waterway gauges into a database for further processing and analysis.

FIG. 3 shows a diagram of the analysis steps of combining waterway gauge data with meteorological data to predict water level changes and thus potential flood points along a waterway.

FIG. 4 shows an illustrative example of the real-time, predictive map created by the present invention, wherein each gauge can be interrogated and predictive maps showing different scenarios can be displayed.

FIG. 5 shows a diagram of the command center deploying the present invention.

FIG. 6 shows an illustrative example of a stream gauge, wherein real-time data related to the waterway (depth, width, flow rate, temperature, etc.) is collected at a given point along the waterway.

FIG. 7 shows a first embodiment of the waterway countermeasures, wherein geotextile flood tubes are utilized to divert flowing water into temporary locations to prevent uncontrolled flooding downstream.

FIG. 8 shows a second embodiment of the waterway countermeasures, wherein expandable containers are deployed opposite waterway levee to collected and contain the water to reduce waterway surge.

FIG. 9 shows a third embodiment of the waterway countermeasures, wherein water is collected within a basin between a levee and a man-made flood wall barrier is created to contain the collected water.

### DETAILED DESCRIPTION OF THE INVENTION

Reference is made herein to the attached drawings. Like reference numerals are used throughout the drawings to depict like or similar elements of the present flood control method. For the purposes of presenting a brief and clear description of the present invention, the preferred embodiment will be discussed as used for locating flood locations along a waterway, collecting the flooding water, and optionally utilizing the collected water for additional benefits. The figures are intended for representative purposes only and should not be considered to be limiting in any respect.

The present invention is a method of predicting flood locations along U.S. waterways in which publically available waterway data is gathered and assimilated into a common database and compared against weather data in real-time. The method contemplates mapping the available data on high resolution maps, whereby points along waterways can be monitored and potential flood locations can be identified well before the arrival of an impending storm system. The data is collected from several sources and transformed into a single unit system, homogenized such that each piece of data can be compared in a side-by-side manner for accurate predictions. The goal is to augment and increase the ability local, state, and federal agencies to combat floods before they occur by pinpointing flood locations and coordinating with the various authorities to establish countermeasures that will ultimately prevent the flood event. After the event has passed, depending on the countermeasures deployed, the diverted water can be stored, treated, and offered to other areas in need of water. The water can be tested for contaminates prior to shipment, or for the purposes of identifying any potential environmental concerns in the waterway.

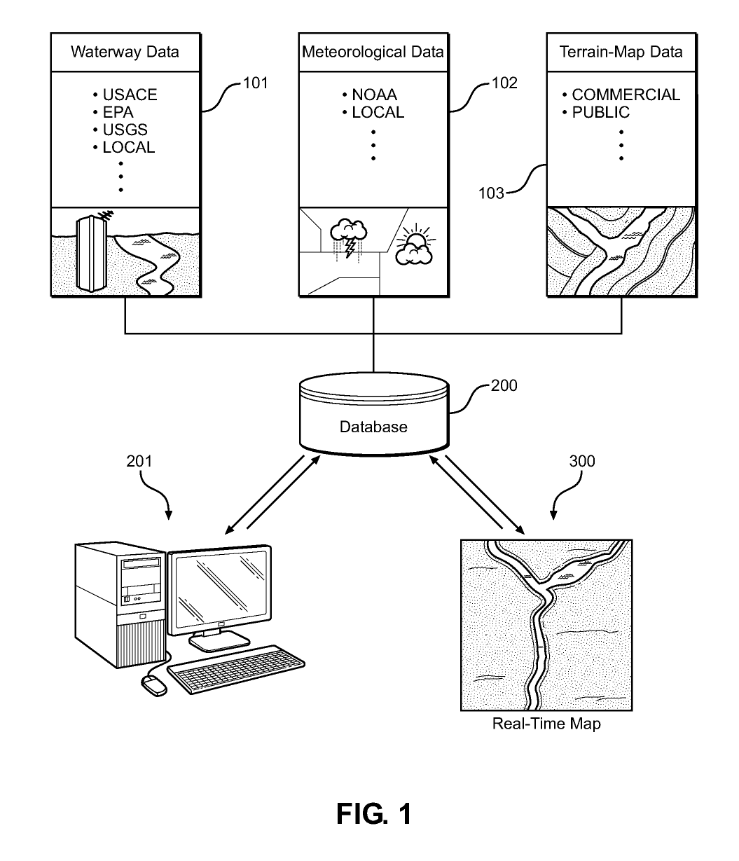

Referring now to FIG. 1, there is shown a diagram outlining the various sources of data that are drawn upon to determine potential flood locations. The present method maximizes available public agency data and deployed technology, whereby the data sources are combined into a single database 200 for developing a real-time statistics and real-time status of U.S. waterways. A computer system 201 is utilized to collect the data from the various sources and input them into a common database, wherefrom technical and administrative analysis can be conducted on the data to develop a real-time map 300 of waterways as storm systems develop and approach. The method assists agencies such as the Army Corps of Engineering (USAGE) and FEMA by analyzing waterways for floods before they occur, whereby flood countermeasures can be deployed as necessary. This in turn reduces annual costs associated with storm clean-up along U.S. waterways, and offers a means to harvest fresh water for markets in drought ridden areas after the event has passed.

The first data set is waterway data 101, which comprises any publically available or privately appropriated source of data for waterways in the United States. At the present time, various government agencies deploy stream gauges along major U.S. waterways and their tributaries as means of monitoring the same. However, these data sources are disparate and the technology has been deployed over time. It is contemplated the present method will combine these data sources such that a comprehensive, real-time map 300 can be created of the data source locations along the waterways, wherefrom predictive models can be created using the data and anticipated storm events in the near future.

The modeling relies heavily on accurate terrain map data 103, wherein measurements of the landscape around the waterway and of the waterway itself are necessary to locate the stream gauges and to predict flood events. Many commercial enterprises exist that provide high resolution digital maps, wherefrom this data is utilized for plotting the stream gauges 101 and for making accurate flood predictions. The predictions include possible breach locations and the resulting extent of flooding the local area. Those areas that are highly populated or have commercial interests are monitored to mobilize countermeasures beforehand and to warn the local population. Those areas of lower concern are also mapped, but may not require active control of the flooding. This decision can only be made based on accurate maps and data points along the waterway. Discrepancies between different maps can be interrogated and resolved with on-site measurements or surveying, while the stream gage locations can likewise be verified over time to ensure their position is accurate.

In combination with knowledge of the terrain and the physical condition of the waterway, changes in the waterway are predicted using meteorological (weather) data 102. Weather patterns are monitored in real-time, as are the waterways, wherein storm system predictions can be entered into calculations to predict any surge in waterway depth or flow rate. This predicted change in condition of the water way is used to create a full model of the waterway during the storm event. Points of interest include those areas that may succumb to a breach, wherein the water level rises above the banks of the waterway and results in local flooding. Predictive models allow administrators the ability to create a plan to divert the waterway or barricade a region against the anticipated flood.

The various agencies drawn upon for the waterway 101 and weather 102 data include the U.S. Army Corps of Engineers (USAGE), the Environmental Protection Agency (EPA), the U.S. Geological Survey (USGS), the National Oceanic and Atmospheric Administration (NOAA), and other federal and local agencies. The data for the waterways is primarily gathered from stream gauges already deployed in U.S. waterways. These gauges monitor water depth, flow rate, and other metrics that are useful for realizing the present conditions of the waterway, and for creating future models thereof based on an impending storm system. Data from the weather services include anticipated rain fall, temperature and pressure changes, wind speed and direction, as well as other important metrics. These are utilized to determine the rise in the waterway, the increase in the flow of the waterway (increase in energy), as well as predicting any backward surge in the waterway from back flowing water from larger bodies of water that might reverse the waterway natural direction.

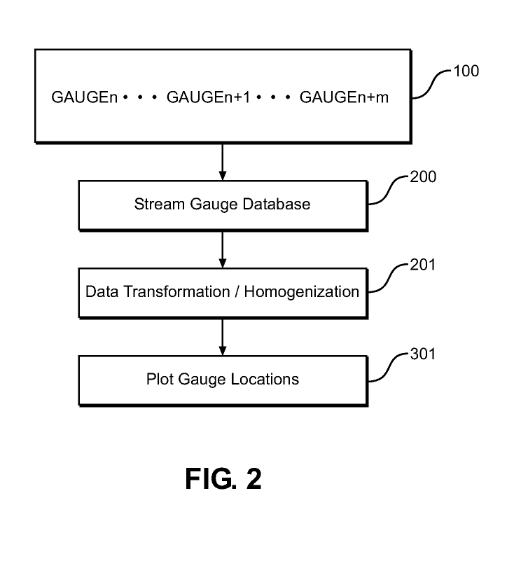

Referring now to FIG. 2, there is shown diagram outlining the method in which all of the disparate waterway gauge data 100 is collected and analyzed in a database 200. The gauges are first identified based on a unit identifier and based on their physical location along a U.S. waterway. The data 100 is generally available in different formats, wherein the data may include different measuring systems and different types of measurement data. The goal of the present method is to organize this data 100 into a database 200, catalog each gauge and homogenize 201 the data such that uniform analysis can be conducted across the data spectrum. The database 200 is capable of adding new gauges as they become available to expand the scope of coverage of the present method. The transformed data 201 is then utilized in a predictive analysis after the gauge locations are plotted 301 on the high resolution maps. Gauge locations that do not match the maps can be verified on the ground using surveying or positioning equipment to ensure accuracy of the measurement.

Generally, publically available data systems for waterways operate independently and are not compatible, and furthermore may have signal interference issues with themselves and the numerous other electronic devices of urban areas. However, the sensors and remote operations can be integrated into one real-time operation and their utility becomes greater than the sum of their parts.

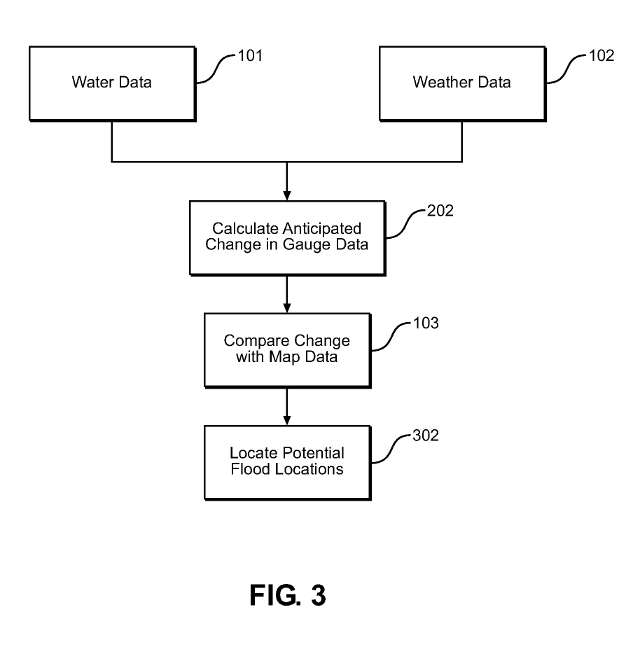

Referring now to FIG. 3, there is shown a diagram outlining the steps taken to pinpoint potential flood locations 302. Once the stream gauge data 101 has been collected, homogenized in a common data output and plotted onto the high resolution maps, weather data 102 is combined therewith to create a predictive model of the waterway during and after a storm event. Based on the weather data predictions from the various weather sources, the anticipated change in the waterway gauge data can be calculated 202. This takes into account the present condition of the waterway, the terrain around the waterway, and the anticipated weather conditions that lead to changes in the waterway. The change is plotted and compared 103 against the map data to locate potential flood locations 302 along the waterway, and further to predict how far the breach in the waterway will extend beyond the natural extents of the waterway pre-storm. This predictive analysis is based on computer modeling and simulation, wherein data points are gathered in real-time and predictive models are created based on anticipated environmental conditions (impending storms and predictions associated therewith).

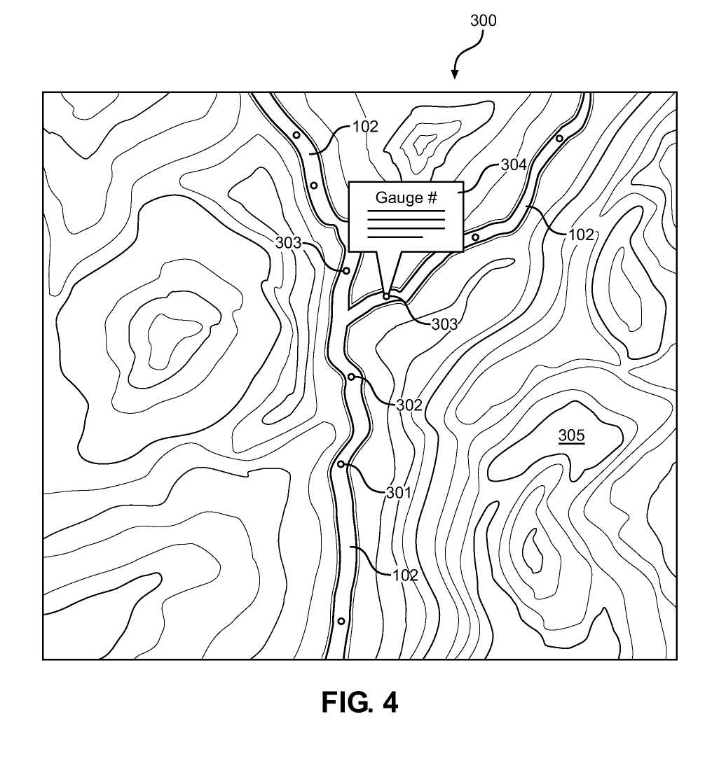

Referring now to FIG. 4, there is shown an illustrative example of the real-time map 300 created by the combination of the stream gauge data, the map data, and the weather data. The map 300 includes highly detailed, accurate topography of the waterway 102 and the surrounding region 305 thereabout. Gauge locations 303 along the waterway 102 are mapped based on their physical location. The map is ideally interactive and interrogatable such that the user can scroll the map location and interrogate individual gauge markers 303. Information 304 pertaining to each gauge can be viewed on the map 300, or alternatively the individual gauge can be queried and interrogated in a separate screen. This screen allows the data from one gauge to be viewed in its entirety, while also providing a function to compare multiple gauges in a database analysis of selected data from a plurality of gauges. The data is updated in real-time and snapshots can be taken at a present time, or from a predicted future time based on the predictive analysis. Overall, the map 300 provides a combination of stream gauge data, map data, and weather data for high level analysis and detailed analysis, wherein real-time and future predictions of flood points can be made.

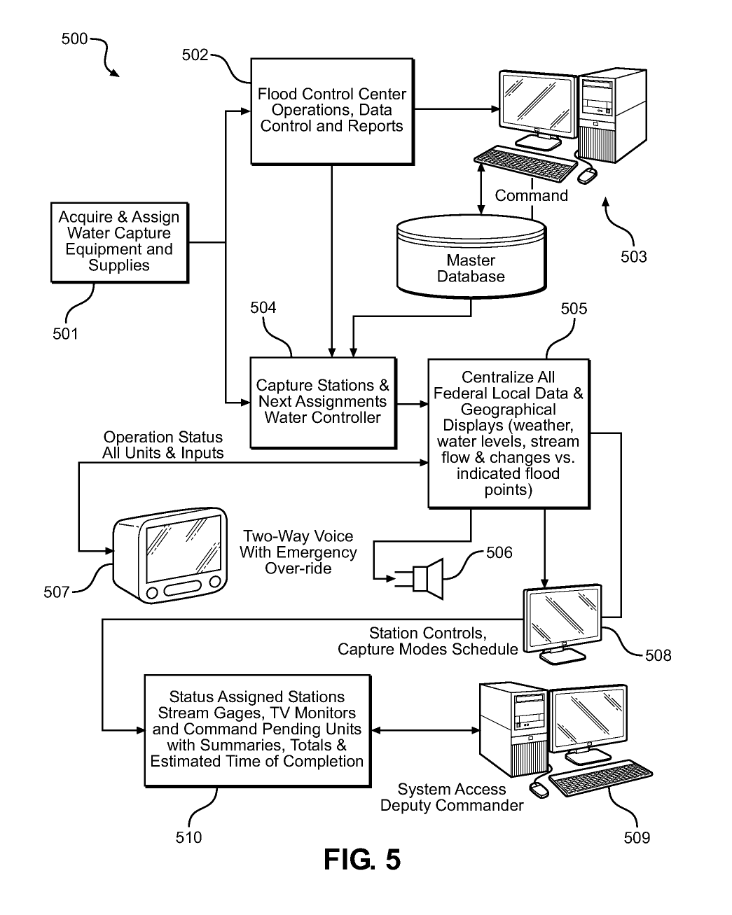

Referring now to FIG. 5, there is shown a view of the command center 500 contemplated for servicing and maintain the present method, along with the various systems utilized to carry out the method. The command center 500 is the organization of the present method and the application thereof. First, the command center is setup 501 by organizing the required tools and equipment necessary to carry out the method and to deploy countermeasures to flood locations. The flood control center operates the analysis 502 using the data collection and analysis method 503, wherefrom flood capture teams can be dispatched to locals around the U.S. to setup capture stations 504. The capture stations 504 are setup nearby the anticipated flood site and coordinate 505 with Federal and local agencies to deploy various countermeasures. The status of the various capture teams is coordinated using various technologies 507, 506 and based on defined schedules 508. The various teams are monitored once deployed, and their real-time status 510 is updated 509 at the flood control center.

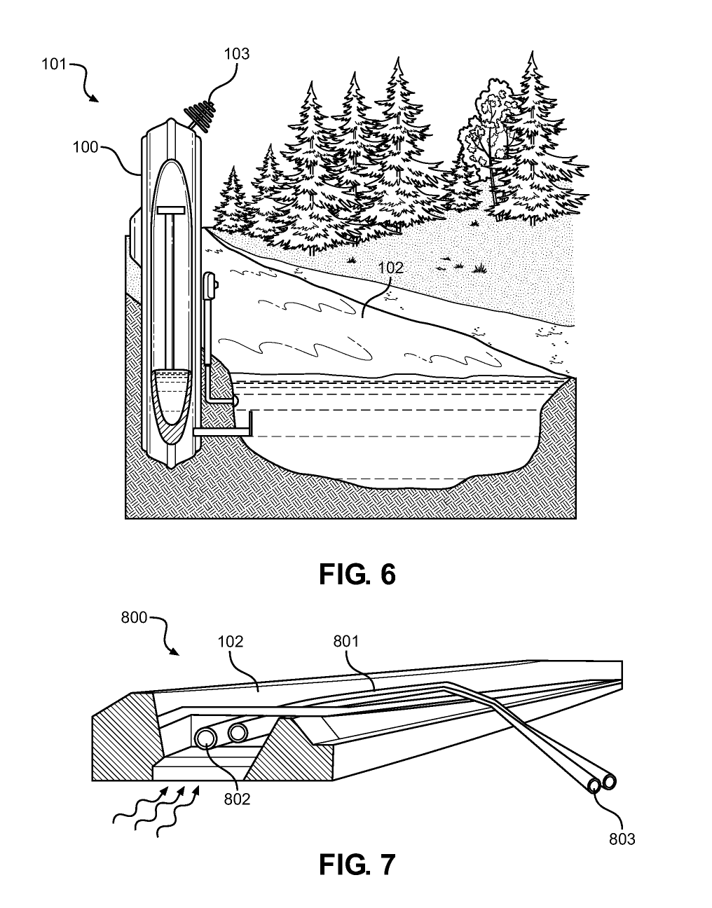

Referring now to FIG. 6, there is shown an illustrative example of a waterway gauge deployed in the field. A majority of the waterway gages are stream gauges 100 that are established adjacent to a moving waterway 102. Metrics such as the stream flow rate, depth, water quality, width of the water, and the location of the stream gauge 100 are reported to an agency database in real-time. These gauges can communicate wirelessly 103, or may be hardwired to a central command location that gathers the gauge data. The present method collects and organizes all publically available stream gauge data for the purpose of creating real-time stream maps for flood prediction modeling.

Referring now to FIG. 7, there is shown a contemplated countermeasure for diverting a waterway 102 once a flood is located. Generally stream gauges along a waterway are spaced 1500 yards apart (approximately). Therefore, once the location of the flood is predicted, the countermeasures can be deployed upstream therefrom to prevent the rise in waterway height. The first countermeasure comprises the use of geotextile pipes 801 having an inlet 82 and an outlet 803. The pipes accept flowing water thereinto, wherefrom the water flows via gravity into the pipe inlet 82 and is diverted to a temporary holding area disposed at the outlet 803 of the pipe 801. If gravity feed is not possible, pumps are placed in-line with the pipes 801 to pump a quantity of water into adjacent areas (reservoirs, flood-capture basins, etc.). Instant-reservoirs can be created from adjacent land to store water up to a few feet deep, or existing reservoirs and basins can be capitalized upon.

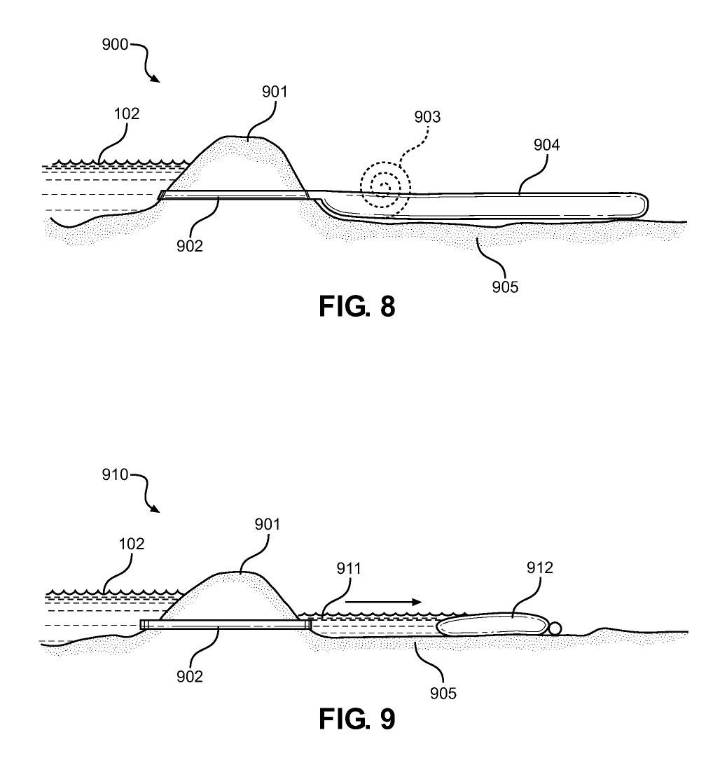

Referring now to FIGS. 8 and 9, there is shown a second 900 and third 910 contemplated flood countermeasure involving a levee 901 and a water tube 904 adjacent to the waterway 102. FIG. 8 shows a water tube 904 connected to a pipe 902 below the levee 901, wherein water from the waterway 102 flows into the tube 904 to expand the same from a rolled state 903 along land 905 adjacent to the waterway. The water tube 904 accepts a designed volume of water to reduce the volume of water flowing down stream. Similarly, a filled water tube 912 or barrier can be setup between a berm and the levee 901, as shown in FIG. 9. The area between the filled water tube 912 and the levee 901 can accept water 911 therein, whereby the area acts as a temporary reservoir. The same setup is used in this embodiment as with the second embodiment, whereby a tube 902 through the levee 901 communicates water from the waterway 102 into the temporary reservoir area.

Water tubes generally hold relatively little water (about 10 acre-feet, for example). The bulk of the water is therefore captured in the temporary reservoir formed by the filled water tube 912 and the levee 901. The filled water tube 912 is a tube accepting water from the water way and directed in parallel to the waterway, whereby a temporary barrier is created by the filled tube 912. The instant reservoir scales up inexpensively since the water tube length increases linearly while the reservoir area increases by the square of the water tube 912 length. That is: if the perimeter of the reservoir increases by three times, the volume of the reservoir increases by a factor of nine times.

As a result of advances in textile manufacturing, the water tubes can be both inexpensive and portable. Unlike earthen levees, any water storage site remains accessible and adaptable, except after storing water has initiated. When not storing water, the tubes can be placed in an open space habitat, soccer field, golf course, even a parking lot area adjacent to a waterway. Property owners in flood plains might agree to short-term easements for the establishment of these countermeasures, wherein the countermeasures prevent large scale flood damage and the capture water can thereafter be sold for a profit. The cost of easement can therefore be paid by the value of the captured water.

Expanding reservoirs and spreading grounds with current technology requires property purchases or extensive grading with associated extensive property transfer safeguards and environmental documentation. Public agencies must spend years ensuring they are spending public money wisely, because money spent on one site will not be available to buy other sites. Similarly, the current property owners will forgo any future benefits from the land they sell. Using water tubes, more property will be available each year simply because both private individuals and public agencies can act quicker on temporary arrangements than on permanent arrangements. Note that instant-reservoir operation can be modified to provide temporary wetlands treatment systems improving the quality of dry season river flows. This would help meet TMDLs for trash, bacteria, and nutrients at lower economic and energy costs than more equipment intensive solutions.

Once the storm event has passed and the countermeasures have captured a quantity of water, the present method contemplates using the water for humanitarian, environmental, and commercial uses. The water can be analyzed for contamination and treated as necessary, wherein the analysis can tell a story about the local environment for the EPA to investigate, and the quality can be assess before relocating the water to an area in need (e.g. drought areas). The water is sampled, tested, treated, and tagged with a unique identifier to maintain control of the water and to realize its source location during shipment and delivery.

Overall, the present invention contemplates a new means of identifying flood locations along U.S. waterways using a public source, data-driven system the collects, organizes, and analyzes available data against accurate mapping of the U.S. waterways. From this data and from weather data, locations along U.S. waterways can be monitored in real-time to determine, pre-storm, where a potential flood may occur. This location is used to deploy water capture teams that set up countermeasures and work with Federal and local authorities to divert the waterway and prepare the local area. Once the event has passed and the water is diverted into temporary or pre-established locations, the water can be analyzed and used for various purposes. Therefore, the present invention reduces flood damage events and capitalizes on natural influxes of fresh water into an area, wherefrom the influx is collected and repurposed.

It is submitted that the instant invention has been shown and described in what is considered to be the most practical and preferred method steps and system embodiments. It is recognized, however, that departures may be made within the scope of the invention, and that obvious modifications will occur to a person skilled in the art. With respect to the above description then, it is to be realized that the optimum steps, materials, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A method of determining likely flood locations along a waterway prior to a storm event, comprising the steps of:
identifying waterway gauge data sources;
importing waterway gauge data from said waterway gauge data sources into an electronic database;
homogenizing said waterway gauge data from each waterway gauge data source into a common data output;
comparing said common data output from all data;
mapping each of said waterway gauge data source locations on a digital map;
updating said common data output in real-time on said digital map;
importing meteorological data from meteorological data sources;
predicting changes in said common data output based on said meteorological data;
determining potential flood locations along a waterway based on the step of predicting changes in said common data output based on said meteorological data.

2. The method of claim 1, further comprising the steps of:
verifying said map and said locations on said digital map.

3. The method of claim 1, further comprising the steps of:
creating an interrogatable digital map that spatially positions each of said waterway gauge data sources.

4. The method of claim 1, further comprising the steps of:
creating a predictive flood map based on the steps of predicting changes in said common data output based on said meteorological data and the steps of determining potential flood locations along a waterway based on the step of predicting changes in said common data output based on said meteorological data.

6. The method of claim 1, the step of identifying waterway gauge data sources further comprises:
identifying publically available waterway gauge data sources.

7. The method of claim 1, the step of identifying waterway gauge data sources further comprises:
acquiring privately acquirable waterway gauge data sources.

8. The method of claim 1, further comprising the steps of:
deploying flood capture teams to a predicted flood location;
determining an appropriate waterway flood countermeasure;
deploying said countermeasure to divert said waterway.

9. The method of claim 8, further comprising the steps of:
coordinating with authorities to prepare said countermeasures.

10. The method of claim 8, wherein the step of deploying said countermeasure to divert said waterway further comprises the steps of:
deploying water capture tubes that divert a volume of said waterway into adjacent capture locations.

11. The method of claim 10, wherein the step of deploying water capture tubes further comprising the steps of:
using water pumps to pump water into said water tubes.

12. The method of claim 8, wherein the step of deploying said countermeasure to divert said waterway further comprises the steps of:
deploying piping below a levee to divert water into an area adjacent o said waterway.

13. The method of claim 12, wherein the step of deploying piping below a levee further comprising the steps of:
filling a water tube with water communicated through said pipe.

14. The method of claim 12, wherein the step of deploying piping below a levee further comprising the steps of:
filling a water tube with water communicated through said pipe;
using said water tube after filling as an outer barrier to trap water between said water tube and said waterway.
